(19) United States
(12) Patent Application Publication
(10) Pub. No.: US 2008/0215678 A1
(43) Pub. Date: Sep. 4, 2008

(54) Bookmarking URLs From An Instant Messaging Session

(76) Inventors: Candice L. Coletrane, Durham, NC (US); Robyn A. McGlotten, Durham, NC (US); William G. Pagan, Durham, NC (US); Wilson Velez, Raleigh, NC (US)

Correspondence Address: IBM (RPS-BLF);c/o BIGGERS & OHANIAN, LLP, P.O. BOX 1469, AUSTIN, TX, 78767-1469, US

(21) Appl. No.: 11/680,878

(22) Filed: Mar. 1, 2007

(51) Int. Cl. G06F 15/16

(52) U.S. Cl. 709/204

(57) ABSTRACT

Bookmarking URLs from an instant messaging session, including identifying by an instant messaging client a URL in the instant messaging session, selecting by the instant messaging client at least one browser available for receiving bookmarks from an instant messaging client, and saving by the instant messaging client a bookmark for the identified URL in a bookmark repository of the selected browser.

### BACKGROUND OF THE INVENTION

1. Field of the Invention

The field of the invention is data processing, or, more specifically, methods, apparatus, and products for bookmarking URLs from an instant messaging session.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is instant messaging. Instant messaging is real-time communication between two or more participants over a data communication network. Users often send links to webpages via instant messages. Administration of such links in current instant messaging client is quite cumbersome, however. The user often does not have time to examine the link when it is received. And in typical instant message clients, there is no way to save such a link for later reference.

### SUMMARY OF THE INVENTION

Methods, apparatus, and products are disclosed for bookmarking URLs from an instant messaging session that include identifying by an instant messaging client a URL in the instant messaging session, selecting by the instant messaging client at least one browser available for receiving bookmarks from an instant messaging client, and saving by the instant messaging client a bookmark for the identified URL in a bookmark repository of the selected browser.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for bookmarking URLs from an instant messaging session according to embodiments of the present invention.

FIG. 2 sets forth a block diagram of automated computing machinery comprising an exemplary computer useful in bookmarking URLs from an instant messaging session according to embodiments of the present invention.

FIG. 3 sets forth a flow chart illustrating an exemplary method of bookmarking URLs from an instant messaging session according to embodiments of the present invention.

FIG. 4A sets forth a line drawing of an example graphical user interface (‘GUI’) of an instant messaging client that bookmarks URLs according to embodiments of the present invention.

FIG. 4B sets forth a line drawing of an additional exemplary data structure useful for saving a bookmark by an instant messaging client according to embodiments of the present invention.

FIG. 5 sets forth a flow chart illustrating a further exemplary method of bookmarking URLs from an instant messaging session according to embodiments of the present invention.

FIG. 6 sets forth a line drawing of a GUI of an exemplary browser for bookmarking URLs from an instant messaging session according to embodiments of the present invention.

### DETAILED DESCRIPTION OF EXEMPLARY EMBODIMENTS

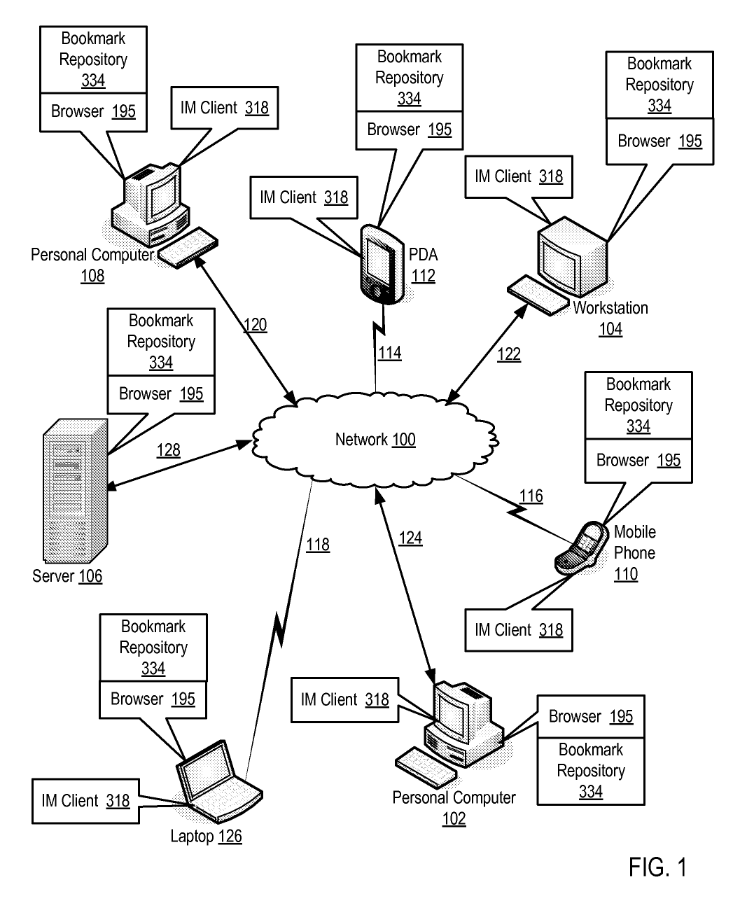

Exemplary methods, systems, and products for bookmarking URLs from an instant messaging session according to embodiments of the present invention are described with reference to the accompanying drawings, beginning with FIG. 1. FIG. 1 sets forth a network diagram illustrating an exemplary system for bookmarking URLs from an instant messaging session according to embodiments of the present invention. Bookmarking URLs from an instant messaging session in this example is implemented with an instant messaging client (318) operating on a computing device. In the system of FIG. 1, an instant messaging client (318) operates generally to bookmark URLs from an instant messaging session according to embodiments of the present invention by identifying a URL in an instant messaging session, selecting at least one browser (195) available for receiving bookmarks from an instant messaging client, and saving a bookmark for the identified URL in a bookmark repository (334) of the selected browser. Operation of the instant messaging client (318) of FIG. 1 may also include the instant messaging client's displaying the saved bookmark as a hyperlink.

Instances of an instant messaging client (318) in the example of FIG. 1 operate on a computing device to bookmark URLs from an instant messaging session. An instant messaging client (318) is a software module of computer programming instructions that bookmarks URLs according to embodiments of the present invention by identifying a URL in an instant messaging session, selecting at least one browser (195) available for receiving bookmarks from an instant messaging client, and saving a bookmark for the identified URL in a bookmark repository (334) of the selected browser.

As the term is used in this specification a ‘browser’ is a software module of computer program instructions configured to allow a user to navigate objects having a connecting structure. The most common kind of browser is a ‘web browser,’ a software application that enables a user to display and interact with text, images, and other information typically located on a web page at a website on the World Wide Web or a local area network. A browser, however, may be any kind of browser as may occur to those of skill in the art, including, for example, Microsoft's Windows Explorer™, which is a file browser for managing files and related objects. It is useful, therefore, to consider a browser as a web browser, but more general in nature. Examples of web browsers that may be useful for bookmarking URLs from an instant messaging session according to embodiments of the present invention include Internet Explorer™, Netscape Communicator™, Mozilla™, Opera™, Mosaic™, and Firefox™.

In the system of FIG. 1, each browser (195) is associated with a bookmark repository (334). A bookmark repository is a data structure in which bookmarks for a particular browser are stored. A bookmark repository may be constructed with any data structure including, for example, a relational database, a flat file, an XML document, or an HTML document. A bookmark repository associated with a browser may be located on the same computing device that the browser is operated or, alternatively, located on a remote computing device, such as a server, removable hard disk, or a hard disk drive of a remote personal computer. A user's bookmarks, therefore, may be stored in a bookmark repository such that the user's bookmarks are accessible from a number of computing devices, the computing devices connected for data communications over a data communications network.

In the system of FIG. 1, bookmarks stored in a bookmark repository (334) may be accessed by a user through a browser (195), or other software application, such as an instant messaging client (318). A bookmark is a reference to a resource, the reference including a URL that identifies the resource. The structure of a bookmark depends upon the structure of bookmark repository. If the bookmark repository (334) is implemented, for example, as an XML document, then a bookmark may be implemented as an XML element within the XML document. If the bookmark repository (334) is implemented, for example, as a directory in a file system, then a bookmark may be implemented as a file in the directory. If the bookmark repository (334) is implemented, for example, as an HTML document, then a bookmark may be implemented as an HTML element within the HTML document.

As mentioned above, the instant messaging client (318), browser (195), and bookmark repository (334) operate on various computing devices. A computing device is an automated device, that is, automated computing machinery, including a computer program or thread of execution running on an automated device. The system of FIG. 1 includes several example computing devices:
personal computer (108) which is coupled for data communications to data communications network (100) through wireline connection (120),
personal digital assistant (‘PDA’) (112) which is coupled for data communications to data communications network (100) through wireless connection (114),
mobile telephone (110) which is coupled for data communications to data communications network (100) through wireless connection (116),
laptop computer (126) which is coupled for data communications to data communications network (100) through wireless connection (118)
server (106) which is coupled for data communications to data communications network (100) through wireline connection (128)
personal computer (102) which is coupled for data communications to data communications network (100) through wireline connection (124)
workstation (104) which is coupled for data communications to data communications network (100) through wireline connection (122)

The system of FIG. 1 includes a data communications network (100) that connects the computing devices of FIG. 1 for data communications. A data communications network for bookmarking URLs from an instant messaging session according to embodiments of the present invention is a data communications network composed of a plurality of computers that function as data communications routers connected for data communications with packet switching protocols or circuit switching networks. Examples of such networks include an Internet Protocol (‘IP’) network, a Public Switched Telephone Network (‘PSTN’), and an Integrated Service Digital Network (‘ISDN’). Such a data communications network may be implemented with optical connections, wireline connections, or with wireless connections. Such a data communications network may include intranets, internets, local area data communications networks (‘LANs’), and wide area data communications networks (‘WANs’). Such a data communications network may implement, for example:
a link layer with the Ethernet™ Protocol or the Wireless Ethernet™ Protocol,
a data communications network layer with the Internet Protocol (‘IP’),
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The arrangement of servers and other computing devices making up the exemplary system illustrated in FIG. 1 are for explanation, not for limitation. Data processing systems useful for bookmarking URLs according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

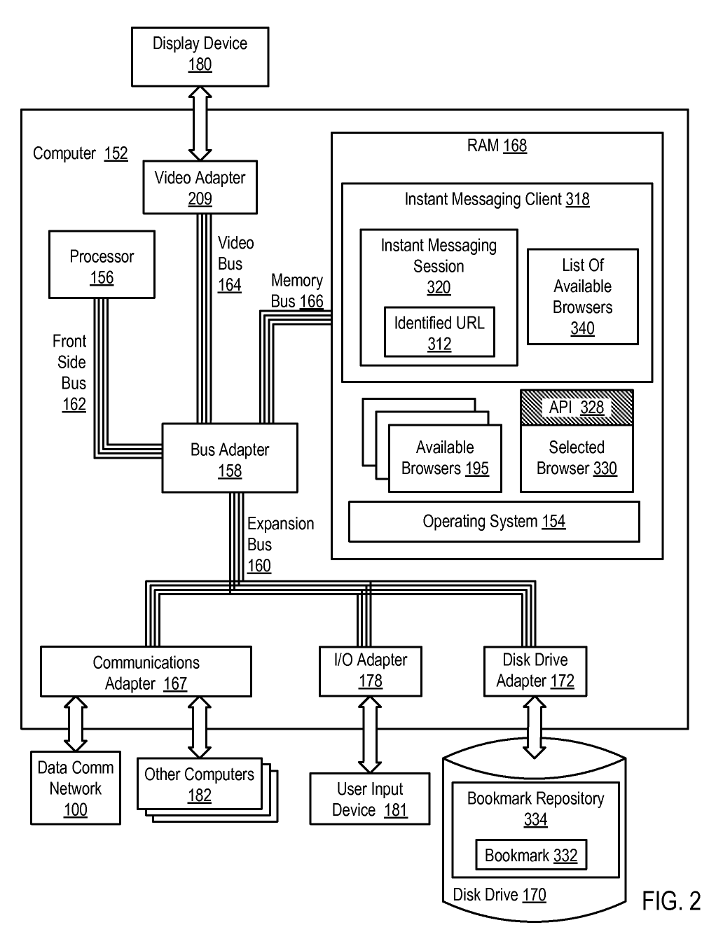

Bookmarking URLs from an instant messaging session in accordance with the present invention is generally implemented with computers, that is, with automated computing machinery. In the system of FIG. 1, for example, the servers (106) and all the computing devices are implemented to some extent at least as computers. For further explanation, therefore, FIG. 2 sets forth a block diagram of automated computing machinery comprising an exemplary computer (152) useful in bookmarking URLs from an instant messaging session according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer.

Stored in RAM (168) is an instant messaging client (318), a module of computer programming instructions that bookmarks URLs according to embodiments of the present invention by identifying a URL (312) in an instant messaging session (320), selecting at least one browser (330) available for receiving bookmarks from an instant messaging client, and saving a bookmark (332) for the identified URL in a bookmark repository (334) of the selected browser. The instant messaging client (318) selects the selected browser (330) from a list (340) of browsers (195) that are available, either on the computer (152) or somewhere across networks in cyberspace, for receiving bookmarks from an instant messaging client. The instant messaging client (318) may save a bookmark by calling a function of an API (328) exposed by the selected browser (330) for saving bookmarks (332) in the bookmark repository (334).

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. The operating system (154), instant messaging client (318), instant messaging session (320), identified URL (312), list (340) of available browsers, available browsers (195), and the selected browser (330) in the example of FIG. 2 are shown stored in RAM (168), but many components of such software typically are stored in non-volatile memory also, for example, on a disk drive (170). In addition, the bookmark repository (334) and the saved bookmark (332) are shown in non-volatile storage (170), but readers will recognize that bookmark repositories and bookmarks saved in such repositories also may be implemented or stored in RAM and in other forms of computer memory as may occur to those of skill in the art.

Computer (152) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in computers according to embodiments of the present invention include the Intel Northbridge, the Intel Memory Controller Hub, the Intel Southbridge, and the Intel I/O Controller Hub. Examples of expansion buses useful in computers according to embodiments of the present invention include Industry Standard Architecture (‘ISA’) buses and Peripheral Component Interconnect (‘PCI’) buses.

Computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The example computer of FIG. 2 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The example computer of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for indexing digitized speech according to embodiments of the present invention include modems for wired dial-up communications, Ethernet (IEEE 802.3) adapters for wired data communications network communications, and 802.11 adapters for wireless data communications network communications.

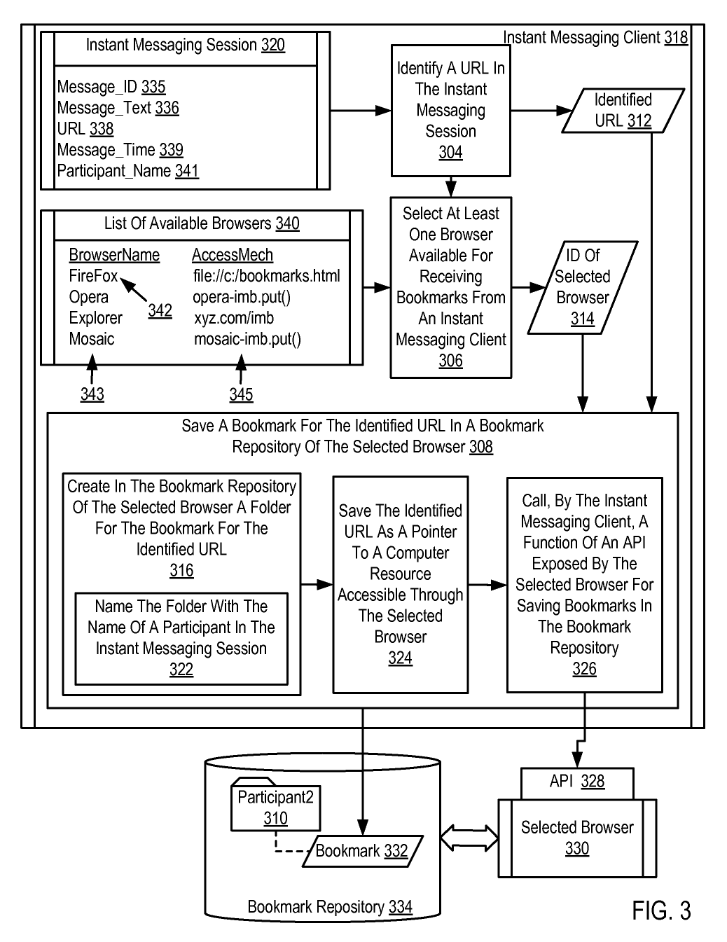

For further explanation, FIG. 3 sets forth a flow chart illustrating an exemplary method of bookmarking URLs from an instant messaging session according to embodiments of the present invention that includes identifying (304) a URL (338) in the instant messaging session (320). In the example of FIG. 3, an instant messaging session (320) is represented as a data structure that includes message text (336) from participants in the instant messaging session as well as one or more URLs (338). In the example of FIG. 3, the instant messaging client (318) is programmed to identify (304) a URL (338) in an instant messaging session (320) by scanning through the content of the instant messaging session and identifying as URLs portions of the content having the format of a URL. URLs, as described in the IETF standard known as RFC 1738, have a format in two parts, a name of a ‘scheme,’ and a ‘scheme specific part.’ A URL contains the name of the scheme being used followed by a colon and then a string, the ‘scheme specific part,’ whose interpretation depends on the scheme. Typical examples of schemes useful in URLs include:
ftp File Transfer protocol
http Hypertext Transfer Protocol
gopher The Gopher protocol
mailto Electronic mail address
news USENET news
nntp USENET news using NNTP access
telnet Reference to interactive sessions
wais Wide Area Information Servers
file Host-specific file names
prospero Prospero Directory Service

Typical examples of URLs include:

```
‘http://www.somewebsite.com,’ a URL of the ‘http’ scheme that
    identifies a location of a website having domain name
    ‘somewebsite.com.’
‘file://drive/subdirectory,’ a URL of the ‘file’ scheme that
    identifies a location of a file on a disk drive.
‘ftp:// someftpsite.com,’ a URL of the ‘ftp’ scheme that identifies a
    location of a file transfer protocol site having the name
    ‘someftpsite.com.’
```

The method of FIG. 3 also includes selecting (306) at least one browser (342) available for receiving bookmarks from an instant messaging client. In the example of FIG. 3, the instant messaging client (318) is configured with a list (340) of available browsers. The available browsers are ‘available’ in that their bookmark repositories are accessible by the instant messaging client anywhere in cyberspace, either accessible at locations identified, for example, by URLs, for direct insertion of bookmarks by the instant messaging client, or accessible through APIs provided for the purpose. In this context, ‘anywhere in cyberspace’ includes storage on local storage devices such as computer memory and disk drive as well as storage on other computers and disk drives connected to the instant messaging client through one or more data communications networks.

The list (340) is implemented in this example as a two-column table, one column named “BrowserName” (343) for names of available browsers and a second column named “AccessMech” (345) for information regarding access mechanisms for the available browsers. Access mechanisms are URLs and API functions. Each record in list (340) represents an available browser and an access mechanism for the browser. Firefox's associated access mechanism in the list (340) of available browser is, for example, shown as a URL, ‘abc.com/imb.’ Opera's associated access mechanism in the list (340) of available browser is, for example, shown as an API function called ‘operaAPI.imb( ).’ And so on. Although the list (340) of available browsers in this example is shown for ease of explanation as a table including only two columns, persons of skill in the art will recognize that such a list may be implemented with a variety of data structures useful for bookmarking URLs from an instant messaging session according to the various embodiments of the present invention.

In the example of FIG. 3, the instant messaging client (318) selects (306) at least one browser (342) available for receiving bookmarks from the instant messaging client (318) by selecting one of the browsers listed as available browsers on list (340).

The instant messaging client may be programmed to automatically select one or more of the listed browsers, or, alternatively, the instant messaging client may be programmed to display the list through a GUI to a user and accept the user's selection or selections of one or more browsers available for receiving bookmarks from the instant messaging client. Other ways of selecting (306) at least one browser (342) available for receiving bookmarks from an instant messaging client will occur to those of skill in the art, and all such ways are well within the scope of the present invention.

The method of FIG. 3 also includes saving (308) a bookmark (332) for the identified URL (312) in a bookmark repository (334) of the selected browser (330). A bookmark repository may be constructed with any data structure including, for example, a relational database, a flat file, an XML document, or an HTML document. Firefox's bookmark repository, for example, is structured as an HTML file, typically stored on a disk drive on a system upon which Firefox is installed. Firefox's bookmark repository is usually named “bookmarks.html” and may be stored on a local disk drive at, for example, C:/Documents & Settings/ExampleUser/Mozilla/Firefox/profiles/profilename.default/bookmarks.html.

In the method of FIG. 3, saving (308) a bookmark (332) includes creating (316) in the bookmark repository (334) of the selected browser (330) a folder (310) for the bookmark (332) for the identified URL (312). A folder for a bookmark is a substructure of a bookmark repository. If the bookmark repository is implemented, for example, as an XML document, then a folder may be implemented as an XML element within the XML document. If the bookmark repository is implemented, for example, as a directory in a file system, then a folder may be implemented as a subdirectory in the directory. If the bookmark repository is implemented, for example, as an HTML document, then a folder may be implemented as an HTML element within the HTML document. Firefox's bookmark repository, for example, an HTML document, describes a folder, for example, as an HTML definition term <dt>, including the date the folder was added, the date the folder was last modified, the folder's resource description framework, and the name of the folder. The following is an example of Firefox HTML code used to describe a folder named ‘Example_Folder’ added Jan. 22, 2007:

<DT><H3 ADD_DATE=“1169489622”
LAST_MODIFIED=“1169489635” ID=“rdf:#$+W.oY2”>
Example_Folder </H3>

Other ways of creating (316) in the bookmark repository (334) of the selected browser (330) a folder (310) for the bookmark (332) for the identified URL (312) will occur to those of skill in the art, and all such ways are well within the scope of the present invention.

In the method of FIG. 3, creating (316) a folder (310) includes naming (322) the folder (310) with the name of a participant in the instant messaging session (320). In the example of FIG. 3, the instant messaging client (318) is programmed to name (322) the folder (310) with the name of a participant in the instant messaging session (320) by identifying a participant's name and using the participant's name to name the folder. The identified participant's name is the name of the participant who sent the message containing a URL (338), and the instant messaging client may identify the participant's name in the example of FIG. 3 by reading the participant's name (341) from the instant messaging session (320). The instant messaging session (320) includes, for each message received by the instant messaging client (318) from a participant, data describing the message including such exemplary data as the text (336) of the message, the time (339) the message was received, the name (341) of the participant that the sent the message, an identification code (335) for each message, and so on.

Using the participant's name so identified to name the folder depends upon the structure of the bookmark repository. If the bookmark repository is an XML document or an HTML document, for example, using the participant's name to name the folder may be carried out by use of an ‘id’ attribute in an XML element or an HTML elements, such as, for example:

<DT><H3 ADD_DATE=“1169489622”
LAST_MODIFIED=“1169489635” ID=“John Doe”>
Example_Folder </H3>

Or by use of an additional sub-element, such as, for example:

```
<DT>
  <H3 ADD_DATE=“1169489622” LAST_MODIFIED=“1169489635”
    ID=“rdf:#$+W.oY2”> Example_Folder
    <participantName>John Doe</participantName> </H3>
  ...
</DT>
```

If the bookmark repository is implemented as a subdirectory in a file system, then the instant messaging engine may use the participant's name to name the folder by using the participant's name as the name of the subdirectory, as, for example: c:\bookmarks\instantMessagingBookmarks\John Doe.

In the method of FIG. 3, saving (308) a bookmark includes saving (324) the identified URL (312) as a pointer to a computer resource accessible through the selected browser. The computer resource can be any computer resource that can be located with a URL and accessed through a browser including, for example, a file, a web page, an audio clip, a video clip, a database record, and so on, as will occur to those of skill in the art. Information saved as the bookmark includes the identified URL, of course, but can also include optionally other pertinent information comprising the bookmark, such as, for example, the fact that the bookmark was saved by the instant messaging client (318) rather than some other application, the name of the participant in the instant messaging session (320) that sent the URL, the time and date the URL was received in the instant messaging session (320), and so on. The bookmark is saved in some data structure, the form of which may be any useful form of data structure—and may depend upon the particular implementation of the bookmark repository. If the bookmark repository is implemented, for example, as an XML document, or HTML document, the data structure in which the bookmark is stored may be an element of the document. Here is an example XML structure for saving a bookmark from an instant messaging client:

```
<imBookmarks>
    <bookmark>
        <URL> ... </URL>
        <displayText> ... </displayText>
        <savedDate> ... </savedDate>
        <imClientID> ... </imClientID>
        <userName> ... </userName>
        <receiveTime> ... </receiveTime>
    </bookmark>
    <bookmark>
        <URL> ... </URL>
        <displayText> ... </displayText>
        <savedDate> ... </savedDate>
        <imClientID> ... </imClientID>
        <userName> ... </userName>
        <receiveTime> ... </receiveTime>
    </bookmark>
    ...
    ...
    ...
<imBookmarks>
```

This example structure includes an element named <imBookmarks> signifying that bookmark elements stored within it are bookmarks from an instant messaging client. Each <bookmark> element within <imBookmarks> includes a storage element named <URL> for an identified URL, as well as storage in <displayText> for a displayable text description of the bookmark, an element named <savedDate> for storing the date and time when the bookmark was saved, an element named <imClientID> for identifying the particular instant messaging client that saved the bookmark—against the possibility that a computer has more than one instant messaging client operable upon it, an element named <userName> for saving a username of the user who sent the identified URL, and an element named <receiveTime> for the date and time when the instant message containing the identified URL was received.

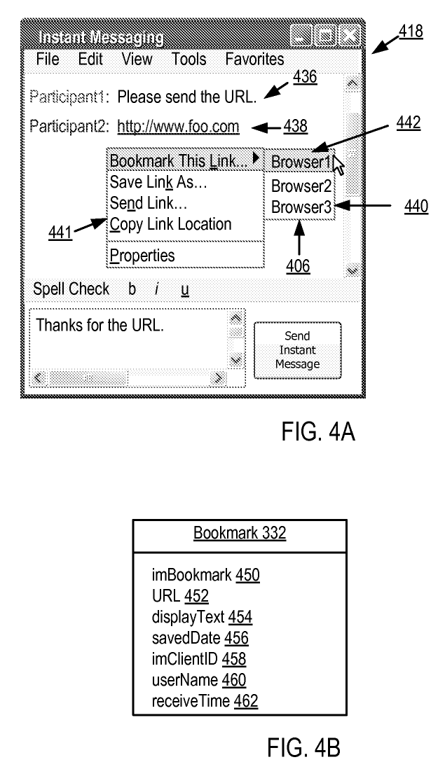

As mentioned, the bookmark may be saved in any useful form of data structure. For further explanation, FIG. 4B sets forth a line drawing of an additional exemplary data structure (332) useful for saving a bookmark by an instant messaging client implemented in C, C++, or as a database. The example bookmark structure of FIG. 4B includes a Boolean data element named imBookmarks (450) whose value signifies whether a particular bookmark is from an instant messaging client, a data element named URL (452) for storing an identified URL, a data element named displayText (454) for a displayable text description of the bookmark, a data element named savedDate (456) for storing the date and time when the bookmark was saved, a data element named imClientID (458) for identifying the particular instant messaging client that saved the bookmark—against the possibility that a computer has more than one instant messaging client operable upon it, a data element named userName (460) for saving a username of the user who sent the identified URL, and a data element named receiveTime (462) for the date and time when the instant message containing the identified URL was received.

In the method of FIG. 3, saving (308) a bookmark includes calling (326), by the instant messaging client (318), a function of an API (328) exposed by the selected browser (330) for saving bookmarks (332) in the bookmark repository (334). In the example of FIG. 3, the instant messaging client (318) is programmed to call (326) a function of an API (328) exposed by the selected browser (330) for saving bookmarks (332) in the bookmark repository (334) by discovering, from the list (340) of available browsers, that the selected browser's (330) access mechanism for the browser's bookmark repository is an API (328) and passing, as an input parameter to the browser's API bookmarking function, the URL to be bookmarked. In the access mechanism column (345) of the example list (340) of FIG. 3, Opera and Mosaic are identified as available browsers whose access mechanisms are APIs. Opera's bookmark repository is accessible through an API named “opera-imb” and a put( ) function in the API, and Mosaic's bookmark repository is accessible through an API named “mosaic-imb” and a similar put( ) function in its API. Here is an example of such an API call in C++-style syntax for a bookmarking function named “put” in an object of an API class named “opera-imBookmark”:
errorCode=opera-imBookmark.put(someURL);

This put( ) function accepted a single parameter, the URL to be bookmarked. In addition to the URL to be bookmarked, however, a browser's bookmarking function may accept any number of input parameters such as, for example, a folder name in which to save the bookmark in a browser's bookmark repository, display text for the bookmark, and so on. Here is an example of a call from an instant messaging client (318) to a bookmarking function that includes as call parameters a URL to be bookmarked as the domain name ‘www.mary.net’, a folder name of a folder in which to save the bookmark in the browser's bookmark repository with the folder named for a participant in an instant messaging session: ‘John Doe,’ and display text to be associated with the bookmark: ‘Mary's website’:

```
errorCode = opera-imBookmark.put(
    string urlToBookmark = “www.mary.net”,
    string folderName = “John Doe”,
    string displayText = “Mary's Website”);
```

In the method of FIG. 3, as an alternative to going through an API, saving (308) a bookmark may include storing (324), by the instant messaging client (318), the bookmark (332) directly in the bookmark repository (334) of the selected browser (330) without calling a function of an API. In the example of FIG. 3, the instant messaging client (318) may be programmed to store (324) the bookmark (332) directly in the bookmark repository (334) of the selected browser (330) by discovering, from the list (340) of available browsers, that the selected browser's (330) associated access mechanism for the browser's bookmark repository is, for example, a URL and constructing a URL query for storing a bookmark directly in the selected browser's (330) bookmark repository (334). In the access mechanism column (345) of the example list (340) of FIG. 3, Firefox and Explorer are identified as available browsers whose access mechanisms are URLs. Explorer's bookmark repository is accessible through a URL named “xyz.com/imb” that identifies the location of Explorer's bookmark repository as the web server named “xyz.” Firefox's bookmark repository however, is accessible through a URL named “file://c:/bookmarks.html” that identifies the location of Firefox's bookmark repository as a local storage device the “c:” drive. A browser's bookmark repository may be accessed by a URL query including the location of the bookmark repository as well as the URL to be bookmarked. Here is an example of such an URL query:
file://c:/bookmarks.html/instantMessagingBookmark?URL=“www.mary.net”

This URL query includes a single parameter, the URL to be bookmarked. In addition to the URL to be bookmarked, however, a URL query may be constructed with any number of input parameters such as, for example, a folder name in which to save the bookmark in a browser's bookmark repository, display text for the bookmark, and so on. Here is an example of URL query constructed by an instant messaging client (318), where the URL query includes as parameters a URL to be bookmarked as the domain name ‘www.mary.net’, a folder name of a folder in which to save the bookmark in the browser's bookmark repository with the folder named for a participant in an instant messaging session: ‘John Doe,’ and display text to be associated with the bookmark: ‘Mary's website’:

file://c:/bookmarks.html/instantMessagingBookmark?
URL=“www.mary.net”
+folder=“John Doe”+displayText=“Mary's Website”

For further explanation, FIG. 4A sets forth a line drawing of an example graphical user interface (‘GUI’) of an instant messaging client that bookmarks URLs according to embodiments of the present invention. The GUI (418) of FIG. 4A is an example of a computer software product improved to bookmark URLs from an instant messaging session, that is, programmed at the source code level to identify a URL in an instant messaging session, select at least one browser available for receiving bookmarks from an instant messaging client, and save a bookmark for the identified URL in a bookmark repository of the selected browser. The exemplary GUI (418) of FIG. 4A, depicts a graphical representation of instant messaging session including message text (436) from participants in the instant messaging session, and one or more URLs (438). In the example GUI (418) of FIG. 4A, the URL (438) in the instant messaging session, “http://www.foo.com” sent by Participant2 to Participant1 is identified by the instant messaging client as described above with reference to FIG. 3. The GUI (418) of FIG. 4A may be programmed to display an identified URL as text that is for example, highlighted, underlined, bolded, or of a specific color so as to identify to a user that such displayed text is a URL. In the exemplary GUI (418) of FIG. 4A the identified URL (438) is depicted as underlined text.

The exemplary GUI (418) of FIG. 4A is an example of a computer software product improved to receive a user's selection of at least one browser (442) available for receiving bookmarks from an instant messaging client. A user may select at least one browser (442) available for receiving bookmarks from an instant messaging client, from, for example, a slide-out selection menu (440) that includes the list of available browsers. The example GUI (418) of FIG. 4A is programmed to display a slide-out selection menu (440) that includes the list (406) of available browsers in response to a user's left mouse-click while the mouse pointer is over the “Bookmark This Link . . . ” option that is included in the pop-up selection menu (441). The pop-up selection menu (441) is displayed by the GUI (418) in response to a user's right mouse-click while the mouse pointer is over an identified URL (438) in the instant messaging session. In the illustrated example, a user right-clicked the mouse while the mouse pointer was over the identified URL (438) “http://www.foo.com,” and then left-clicked the mouse while the mouse pointer was over the “Bookmark This Link . . . ” option in the pop-up selection menu (441). The user has navigated the mouse pointer over “Browser1” in the list (406) of available browser's and may further select such available browser by left-clicking on the mouse while the pointer is over “Browser1.” Although FIG. 4A depicts a selection of only one browser available for saving a bookmark, persons of skill in the art will recognize that a user may select more than one browser by for example, holding the ‘control’ key on a keyboard while left-clicking on more than one browser, or selecting a checkbox for more than one browser.

Upon receiving, through the GUI (418) a user's selection of at least one browser (442) available for receiving bookmarks from an instant messaging client, the instant messaging client is programmed to save, as described above with reference to FIG. 3, a bookmark for the identified URL in a bookmark repository of the selected browser. In the illustrated example, upon left-clicking, by a user, on the mouse while the mouse pointer is over the “Browser1” option in the list (406) of available browsers, the instant messaging client will save a bookmark for the identified URL, “http://www.foo.com” in the bookmark repository of the selected browser, “Browser1.”

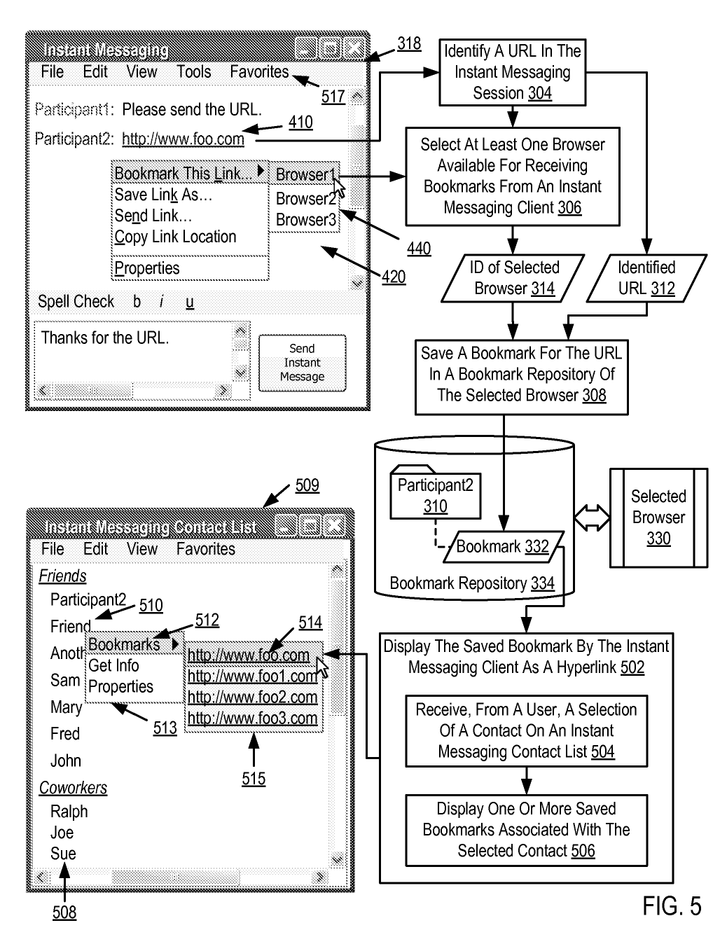

For further explanation, FIG. 5 sets forth a flow chart illustrating a further exemplary method of bookmarking URLs from an instant messaging session according to embodiments of the present invention. The method of FIG. 5 is similar to the method of FIG. 3, including as it does identifying (304) a URL (338) in the instant messaging session (320), selecting (306) at least one browser (342) available for receiving bookmarks from an instant messaging client, and saving (308) a bookmark (332) for the identified URL (312) in a bookmark repository (334) of the selected browser (330). The method of FIG. 5, however, also includes displaying (502) the saved bookmark (332) by the instant messaging client (318) as a hyperlink (514). A hyperlink is a reference to a URL which when invoked requests access to a resource identified by the URL. A hyperlink may be displayed on a graphical user interface (‘GUI’) as the anchor text from an HTML anchor element, such as, for example:
<a href=“www.someURL.com” title=“Some URL”>Click Here</a>;
   where the hyperlink is displayed as “Click Here” and retrieves the web page at www.someURL.com when invoked. An anchor element is a markup language element from HTML, XHTML, and the like, that identifies and implements a hyperlink. The example anchor element set forth above includes a start tag <a>, and end tag </a>, an href attribute that identifies the target of the link as a domain named ‘someURL.com,’ and an anchor. The ‘anchor element’ is the entire markup from the start tag to the end tag. The “anchor” is the display text that is set forth between the start tag and the end tag. That is, in this example, the anchor is the text “Click Here.” The anchor often is displayed in highlighting, underscored, inverse, specially colored, or some other fashion setting it apart from other screen text and identifying it as an available hyperlink. In addition, the screen display area of the anchor is sensitized to user interface operations, GUI pointer operations, mouseclicks, and the like. A user may, for example, point to the anchor with a mouse pointer or other GUI pointer and click on the anchor to invoke the link.

In the example of FIG. 5, the instant messaging client (318) is programmed to display (502) the saved bookmark (332) as a hyperlink (514) by locating the saved bookmark for the identified URL (312) in the bookmark repository (334) of the selected browser (330) and displaying the URL as a hyperlink (514) on a display. In the example of FIG. 5, the instant messaging client (318) may be programmed to locate a saved bookmark (332) for the identified URL (312) in the bookmark repository (334) by scanning the bookmark repository (334) for information saved as bookmarks that matches an instant messaging client identification code of the instant messaging client (318), information that matches an instant messaging participant's name, a match on a bookmark save date or a message receipt date, and so on. In the example of FIG. 5, the instant messaging client (318) may display the URL of the located bookmark as a hyperlink (514) on a GUI, in a number of ways including for example, in pop-up selection list (515), a pull-down selection list from a menu bar item (517) named “Favorites,” and so on.

In the method of FIG. 5, displaying (502) the saved bookmark (332) as a hyperlink (514) includes receiving (504), from a user, a selection of a contact (510) on an instant messaging contact list (508) and displaying (506) one or more saved bookmarks (332) associated with the selected contact (510). The instant messaging client (318) may receive (504), from a user, a selection of a contact (510) on an instant messaging contact list (508) from user operations of a GUI. The instant messaging client (318) of FIG. 5 is programmed to display a pop-up selection menu (513) in response to a user's right mouse-click while the mouse pointer is over a contact (510) on an instant messaging contact list (508). In the illustrated example, a contact (510) named “Friend” on an instant messaging contact list (508) has been right-mouse-clicked. The pop-up selection menu (513) includes contact specific options such as “Bookmarks,” “Get Info,” and “Properties.” Such a pop-up selection menu may be implemented as an HTML table, coded for example, as:

<table name=“table1”>
<tr><td><a href= “#table2”>Bookmarks</a> <td></tr>
<tr><td><a href= “#getInfo”>Get Info</a> <td></tr>
<tr><td><a href= “#getProperties”>Properties</a> <td></tr>
</table>

In the method of FIG. 5, displaying (502) the saved bookmark (332) as a hyperlink (514) also includes displaying (506) one or more saved bookmarks (332) associated with the selected contact (510). In the example of FIG. 5, the instant messaging client (318) is programmed to display (506) one or more saved bookmarks (332) associated with the selected contact (510) through the GUI (509). The exemplary instant messaging client (318) of FIG. 5 is also programmed to display on the GUI a slide-out selection menu (515) in response to a user's left mouse-click on the “Bookmarks” option in the pop-up selection menu (513). In the illustrated example, a mouse has been left-clicked by a user, while the mouse pointer was over the “Bookmarks” option in the pop-up selection menu (513), accessing the slide-out selection menu (515) that includes one or more saved bookmarks (332) displayed as hyperlinks. Such a slide-out selection menu (515) may be implemented as an HTML table, coded for example, as:

<table name=“table2”>
<tr><td><a href= “http://www.foo.com”>http://www.foo.com</a><td>
</tr>
<tr><td><a href= “http://www.foo1.com”> http://www.foo1.com</a>
<td></tr>
<tr><td><a href= “http://www.foo2.com”> http://www.foo2.com</a>
<td></tr>
<tr><td><a href= “http://www.foo3.com”> http://www.foo3.com</a>
<td></tr>
</table>

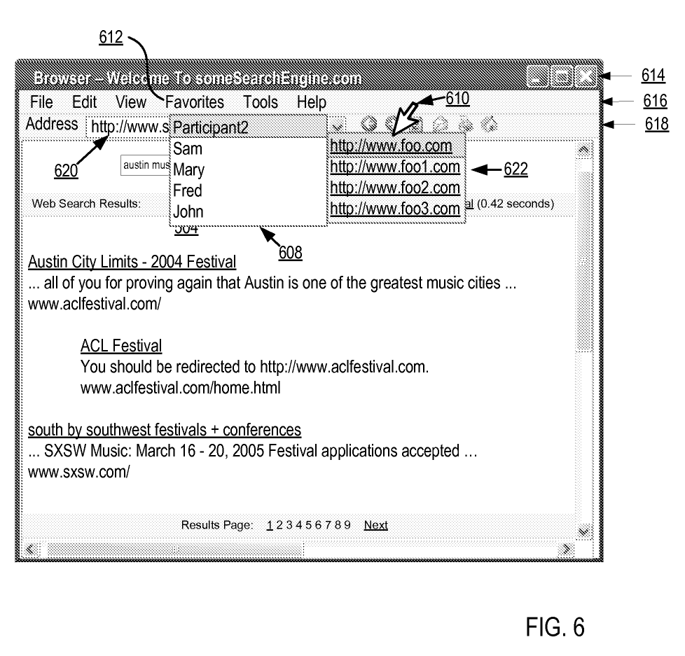

When an instant messaging client according to embodiments of the present invention bookmarks URLs in a bookmark repository of a browser, then the browser can retrieve and display those bookmarks on a user interface where they can be accessed by a user. For further explanation, therefore, FIG. 6 sets forth a line drawing of a GUI of an exemplary browser, a module of computer program instructions improved for bookmarking URLs from an instant messaging session according to embodiments of the present invention. That is, the example browser of FIG. 6 is programmed at the source code level or modified with a plug-in, to display a bookmark saved by an instant messaging client as a hyperlink. The browser of FIG. 6, as depicted, has been operated to point to a web site named “someSearchEngine.com,” as shown in the title bar (614) of the browser display. The browser of FIG. 6 also includes a horizontal menu bar (616) containing menu items named: “File,” “Edit,” “View,” “Favorites” (called “Bookmarks” on some browsers), “Tools,” and “Help.” Bookmarks, in this example, are in fact referenced as “Favorites” (612), which readers will recognize as common practice in the art. In other examples, bookmarks are referred to as a ‘hotlist.’ Bookmarks may also be referred to by other terms from time to time, and the use of all such terms referring to bookmarks is well within the scope of the present invention. The browser of FIG. 6 includes a GUI toolbar (618) with a Back button, a Forward button, and buttons for refreshing the display, emailing the display, printing the display, and returning to a home page configured in the browser. The exemplary browser of FIG. 6 includes an address bar (620) for use in browser navigation.

The browser of FIG. 6 is programmed to display a drop-down selection menu (608) in response to a left-mouse-click on “Favorites” (612) in the horizontal menu bar (616). In the illustrated example, mouse pointer (610) has been left-clicked over “Favorites” in the horizontal menu bar (616) to display the drop-down menu (608). The first menu item on drop-down selection menu (608) is named “Participant2.” The browser in this example is programmed to operate in response to the selection of the menu item named “Participant2” by displaying as hyperlinks in slide-out menu (622) bookmarks saved by an instant messaging client in the browser's bookmark repository. The browser may display the saved bookmarks as hyperlinks, by locating the saved bookmarks in a folder named “Participant2” in the browser's bookmark repository, and rendering the bookmark as a hyperlink as described above. In the example GUI display of FIG. 6, the bookmarks associated with “Participant2” are portrayed in the slide-out menu (622). In this example, the bookmarks displayed as hyperlinks are represented with anchor text comprised of the identified URL for each bookmark, “http://www.foo.com,” “http://www.foo1.com,” and so on. Alternatively, bookmarks displayed as hyperlinks may be represented by display text saved as part of the bookmark to make the bookmark's hyperlink more reader-friendly, “Foo's Home Web Page,” for example.

Exemplary embodiments of the present invention are described largely in the context of a fully functional computer system for bookmarking URLs from an instant messaging session. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of bookmarking Uniform Resource Locators (‘URLs’) from an instant messaging session, the method implemented with an instant messaging client operating on a computing device, the method comprising:
identifying by the instant messaging client a URL in the instant messaging session;
selecting by the instant messaging client at least one browser available for receiving bookmarks from an instant messaging client; and
saving by the instant messaging client a bookmark for the identified URL in a bookmark repository of the selected browser.

2. The method of claim 1 wherein saving a bookmark further comprises saving the identified URL as a pointer to a computer resource accessible through the selected browser.

3. The method of claim 1 wherein saving a bookmark further comprises creating in the bookmark repository of the selected browser a folder for the bookmark for the identified URL.

4. The method of claim 3 wherein creating a folder further comprises naming the folder with the name of a participant in the instant messaging session.

5. The method of claim 1 wherein saving a bookmark further comprises calling, by the instant messaging client, a function of an API exposed by the selected browser for saving bookmarks in the bookmark repository.

6. The method of claim 1 further comprising displaying the saved bookmark by the instant messaging client as a hyperlink.

7. The method of claim 6 wherein displaying the saved bookmark as a hyperlink further comprises:
receiving, from a user, a selection of a contact on an instant messaging contact list; and
displaying one or more saved bookmarks associated with the selected contact.

8. An apparatus for bookmarking URLs from an instant messaging session, the apparatus implemented with an instant messaging client operating on a computing device, the apparatus comprising a computer processor, a computer memory operatively coupled to the computer processor, the computer memory having disposed within it computer program instructions capable of:
identifying by the instant messaging client a URL in the instant messaging session;
selecting by the instant messaging client at least one browser available for receiving bookmarks from an instant messaging client; and
saving by the instant messaging client a bookmark for the identified URL in a bookmark repository of the selected browser.

9. The apparatus of claim 8 wherein saving a bookmark further comprises creating in the bookmark repository of the selected browser a folder for the bookmark for the identified URL.

10. The apparatus of claim 9 wherein creating a folder further comprises naming the folder with the name of a participant in the instant messaging session.

11. The apparatus of claim 8 wherein saving a bookmark further comprises calling, by the instant messaging client, a function of an API exposed by the selected browser for saving bookmarks in the bookmark repository.

12. The apparatus of claim 8 further comprising computer program instructions capable of displaying the saved bookmark by the instant messaging client as a hyperlink.

13. The apparatus of claim 12 wherein displaying the saved bookmark as a hyperlink further comprises:
receiving, from a user, a selection of a contact on an instant messaging contact list; and
displaying one or more saved bookmarks associated with the selected contact.

14. A computer program product for bookmarking URLs from an instant messaging session, the instant messaging session implemented with an instant messaging client operating on a computing device, the computer program product disposed upon a computer-readable, signal bearing medium, the computer program product comprising computer program instructions capable of:
identifying by the instant messaging client a URL in the instant messaging session;
selecting by the instant messaging client at least one browser available for receiving bookmarks from an instant messaging client; and
saving by the instant messaging client a bookmark for the identified URL in a bookmark repository of the selected browser.

15. The computer program product of claim 14 wherein the signal bearing medium comprises a recordable medium.

16. The computer program product of claim 14 wherein the signal bearing medium comprises a transmission medium.

17. The computer program product of claim 14 wherein saving a bookmark further comprises creating in the bookmark repository of the selected browser a folder for the bookmark for the identified URL.

18. The apparatus of claim 9 wherein creating a folder further comprises naming the folder with the name of a participant in the instant messaging session.

19. The computer program product of claim 14 wherein saving a bookmark further comprises calling, by the instant messaging client, a function of an API exposed by the selected browser for saving bookmarks in the bookmark repository.

20. The computer program product of claim 14 further comprising computer program instructions capable of displaying the saved bookmark by the instant messaging client as a hyperlink.
